(19) United States
(12) Patent Application Publication
(10) Pub. No.: US 2017/0061546 A1
(43) Pub. Date: Mar. 2, 2017

(54) MANAGEMENT SYSTEM AND MANAGEMENT METHOD OF RADAR TERMINAL

(71) Applicant: DIGITAL EDGE INC., Seoul (KR)

(72) Inventors: Hee Jin YANG, Seoul (KR); Soo Ho CHOI, Seongnam-si, Gyeonggi-do (KR)

(73) Assignee: DIGITAL EDGE INC., Seoul (KR)

(21) Appl. No.: 15/119,981

(22) PCT Filed: Feb. 23, 2015
(86) PCT No.: PCT/KR2015/001722

§ 371 Date: Aug. 18, 2016

(30) Foreign Application Priority Data
Mar. 24, 2014 (KR) 10-2014-0033784
Jul. 18, 2014 (KR) 10-2014-0090929

(51) Int. Cl. G06Q 40/08; G01S 13/93; G06Q 30/02

(52) U.S. Cl. CPC G06Q 40/08; G06Q 30/0207; G01S 13/931

(57) ABSTRACT

Provided are a management system and a management method of a radar terminal, comprising: a manufacturer server for storing manufacture information of a radar terminal which provides a collision alert and an accident recording function; a mobile carrier server for managing trade information, maintenance information, and business information of the radar terminal in conjunction with the manufacturer server; and an insurance company server for managing insurance information of a vehicle on which the radar terminal is mounted, wherein the insurance company server is configured to provide radar terminal information and premium reduction information to a user terminal, thereby obtaining the effects of inducing propagation of the radar terminal in conjunction with the manufacturer server, the mobile carrier server and the insurance company server, and being capable of managing order subscription, trade information and maintenance history information of the radar terminal.

### TECHNICAL FIELD

The embodiment relates to a system for managing a radar terminal and a method thereof, and more particularly, to a system for managing a radar terminal which detects a distance from a target, a speed and an angle by using a radar signal to prevent a collision and records an accident sequence when a collision occurs, and a method thereof.

### BACKGROUND ART

In recent years, due to the insurance crimes continuously increased as well as safe driving of a vehicle, the installation of a vehicle black box for photographing a traffic accident situation and storing the photographed images has been increased.

Such a vehicle black box has had an important role in determining the cause of an accident.

As examples, vehicle black boxes have been disclosed in Patent Document 1 (Korean Unexamined Patent Publication No. 10-2013-0050410 published on May 16, 2013) and Patent Document 2 (Korean Unexamined Patent Publication No. 10-2002-0030461 published on Apr. 25, 2002).

Patent Document 1 discloses a black box for a vehicle which photographs driving situations of the vehicle in front and rear directions and stores the images in an SD memory card and measures a distance from a front vehicle by using a short-range radar (SRR) sensor installed thereto during travelling. When the distance between the vehicle and a metallic obstacle is in a predetermined range, the black box outputs an alarm.

Patent Document 2 discloses a black box which allows a vehicle owner to prohibit his vehicle from being ignited when the vehicle is stolen, and stores information about a driving state of the vehicle in real time while the vehicle is travelling. When an accident occurs, the black box reproduces the situation at the time of the accident through a simulation of images of the present vehicle and the counterparty vehicle.

That is, according to the related art, various kinds of sensors such as a short-range radar sensor are applied to a vehicle black box to sense whether a collision occurs.

The radar sensor is a sensor unit which transmits a radio wave by using a microwave and receives a signal partially reflected upon a target such that a distance, a speed and an angle are measured.

Such a radar sensor obtains information about a target by using various radar waveforms of a pulsed Doppler radar, a frequency modulated continuous wave (FMCW) radar, a stepped-frequency continuous wave (SFCW) radar, a frequency shift keying (FS K) radar, etc.

In general, the pulsed Doppler radar is used for detecting an object in a long range and the FMCW, SFCW and FSK radars are used for detecting an object in a short range.

However, a vehicle black box according to the related art simply stores only images so that it is difficult to previously prevent an accident from occurring.

In addition, when an accident occurs, the radar sensor of a vehicle black box according to the related art cooperates with an image recording device of the black box only to provide a function of informing the black box of the photographing time point of an image before the collision occurs.

Thus, the applicant has develop a radar device having function of alerting a collision and preventing an accident, which is capable of overcoming the limitations of a vehicle black box according to the related art, where the radar device prevents an accident from occurring by alerting a collision danger before the collision occurs and exactly records the accident sequence when the accident occurs.

### DISCLOSURE

### Technical Problem

Meanwhile, in spite of the merit of a radar device having the functions of alerting a collision and recording an accident, due to a lack of understanding of a general user and additional cost increasing, the radar device has not been popularized yet.

Therefore, there is a need to easily popularize a radar device, which is capable of previously preventing an accident from occurring and more exactly securing an accident sequence such that the record of the radar device is utilized, in conjunction with a mobile communication service provider, a property insurance company and a vehicle manufacturer.

One object of the disclosure is to provide a system for managing a radar terminal which popularizes and manage the radar terminal having functions of alerting a collision and recording an accident, and a method thereof.

Another object of the disclosure is to provide a system for managing a radar terminal which is capable of creating a new model by inducing the radar terminal to be to be popularized in conjunction with a mobile carrier server, an insurance company server and a vehicle manufacturer server, and a method thereof.

### Technical Solution

To achieve the objects, in accordance with an aspect of the disclosure, there is provided a system for managing a radar terminal, which includes a manufacturer server for storing information about manufacture of the radar terminal which provides a function of alerting an collision and recording an accident; a mobile carrier server for managing information about trade in the radar terminal, maintenance of the radar terminal, and business for the radar terminal in conjunction with the manufacturer server; and an insurance company server for managing information about insurance of a vehicle on which the radar terminal is mounted, wherein the insurance company server provides information about the radar terminal and discount on a premium to a user terminal.

In accordance with another aspect of the disclosure, there is provided a system for managing a radar terminal, which includes: a manufacturer server for storing information about manufacture of a radar terminal which provides a function of alerting an collision and recording an accident; a mobile carrier server for managing information about trade in the radar terminal, maintenance of the radar terminal, and business for the radar terminal in conjunction with the manufacturer server; and providing a program in conjunction of a radar terminal and hierarchy of information about a vehicle operation; a vehicle manufacturer server for managing information about a vehicle on which the radar terminal is mounted; and a user terminal for receiving information about the radar terminal from the vehicle manufacturer server to offer an order when a new-vehicle purchasing contract is made.

In accordance with still another aspect of the disclosure, there is provided a method of managing a radar terminal, which includes: (a) providing information about the radar terminal and discount of a premium from an insurance company server to a user terminal, wherein the radar terminal provides functions of alerting an collision and recording an accident; (b) offering an order for the radar terminal to the insurance company server and accessing to a mobile miner server to offer a service reservation by the radar terminal; (c) refunding a premium corresponding to a preset discount rate to the insurance company server by the mobile carrier server when installation of the radar terminal to a user vehicle is completed; and (d) providing information about the discounted premium from the insurance company server to the user terminal.

In accordance with still another aspect of the disclosure, there is provided a method of managing a radar terminal, which includes: (e) providing information about a vehicle and a radar terminal from a vehicle manufacturer server to a user terminal, wherein the radar terminal provides functions of alerting an collision and recording an accident; (f) offering an order for the radar terminal to the insurance company server by the user terminal; (g) generating information about supplying of the radar terminal by the franchisee server when the radar terminal is supplied based on the radar terminal offering and installed to a vehicle of a user; and (h) settling a payment on the radar terminal from the vehicle manufacturer server to a franchisee server and providing an incentive from the manufacturer server to a mobile carrier server.

### Advantageous Effects

As described above, the system for managing a radar terminal and a method thereof according to the disclosure may induce the radar terminal to be popularized in conjunction with the manufacturer server, the mobile carrier server and the insurance company server through the insurance model of the radar terminal having the functions of alerting a collision and recording an accident, and may manage information about the contract of the order for the radar terminal, the trade in the radar terminal, and the maintenance and repair history of the radar terminal.

Thus, according to the disclosure, a new revenue model may be created without any burden of the premium reduction due to the reduction of the number of vehicles subscribed in insurance of a property insurance company and the premium discount supported by a mobile communication service provider. In addition, the new revenue model may allow the mobile communication service provider to obtain sales profit due to the increase of the number of subscribers. Further, the disclosure may enhance the brand value of a radar terminal manufacturer and may market the radar terminal through a mobile communication service provider and a property insurance company so that a stable market may be formed.

In addition, according to the disclosure, when a new-vehicle purchasing contract is made, the information about a radar terminal may be provided from the vehicle manufacturer server to the user terminal 40, and a program such as a navigation application and hierarchy of information about a vehicle operation may be provided to the vehicle and the user terminal.

Thus, the disclosure may allow a vehicle manufacturer to create new revenue through brand marketing using vehicle accident reduction and preoccupancy of radar terminal installation market and increase the number of subscribers of a mobile communication service provider to increase the sales profit.

In addition, according to the disclosure, a new revenue model may be created by providing a program in conjunction with the radar terminal and the hierarchy of information about a vehicle operation, the brand value of a manufacturer may be increased, and a stable market may be formed.

### DESCRIPTION OF DRAWINGS

FIG. 1 is a block diagram illustrating a system for managing a radar terminal according to a first embodiment of the disclosure.

FIG. 2 is a flowchart illustrating a managing method of the system for managing a radar terminal according to the first embodiment of the disclosure.

FIG. 3 is a block diagram illustrating a system for managing a radar terminal according to a second embodiment of the disclosure

FIG. 4 is a flowchart illustrating a managing method of the system for managing a radar terminal according to the second embodiment of the disclosure.

### BEST MODE

### Mode for Invention

Hereinafter, a system for managing a radar terminal and a method thereof according to a preferable embodiment of the disclosure will be described in detail with reference to accompanying drawings.

### First Embodiment

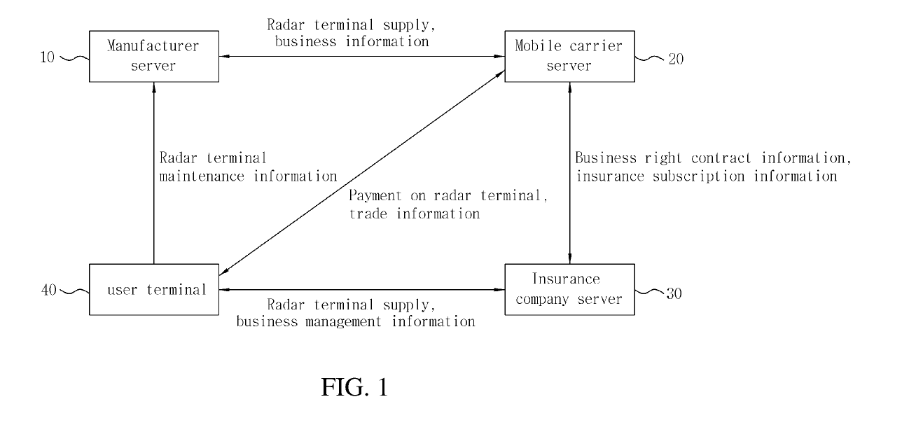

FIG. 1 is a block diagram illustrating a system for managing a radar terminal according to a first embodiment of the disclosure.

In the first embodiment, an insurance model, which provides information about a radar terminal product when vehicle insurance is subscribed and discount on the premium when the radar terminal is installed to induce the radar terminal to be installed in an after-market, will be described.

As shown in FIG. 1, a system for managing a radar terminal according to the first embodiment includes a manufacturer server 10 for storing information about manufacture of a radar device (hereinafter, referred to as a radar terminal) for providing functions of alerting a collision and recording an accident, a mobile carrier server 20 for managing information about trade in the radar terminal, maintenance of the radar terminal, and business for the radar terminal in conjunction with the manufacturer server 10, and an insurance company server 30 for managing information about insurance of a vehicle to which the radar is installed.

In addition, the system for managing a radar terminal according to the first embodiment of the disclosure may further include a user terminal 40 which receives information about a radar terminal through the insurance company server 30 and communicates with the mobile carrier server 20 to transmit or receive information about an order and payment for the radar terminal, and trade in the radar terminal. In addition the user terminal 40 may access to the manufacturer server 10 to request maintenance and transmit or receive information about maintenance history.

In the first embodiment, a manufacturer may provide the radar terminal to a mobile communication service provider and may provide a technical support and maintenance for the radar terminal.

Thus, the manufacturer server 10 may store information about manufacture of the manufactured radar terminal, receive information about the trade in the corresponding radar terminal from the mobile carrier server 20. In addition, the manufacturer server 10 may generate information about the maintenance of a radar terminal when the maintenance of the radar terminal is performed and transfer the generated information to the mobile carrier server 20.

To this end, the manufacturer server 10 may include a database (not shown) for storing the information about the manufacture, trade and maintenance of the radar terminal, a communication unit (not shown) for communicating with the mobile carrier server 20 and the user terminal 40, and a control unit (not shown) for generating and managing the information about the supply and maintenance history of the radar terminal.

A mobile communication service provider handles business for a manufacturer through a contract with the manufacturer so that the radar terminals are supplied, and provides franchise through a contract with a property insurance company.

So, the mobile carrier server 20 may receive information about manufacture of a radar terminal from the manufacturer server 10 and receive the order of a radar terminal from the user terminal 40 to generate and manage information about the trade of the sold radar terminal. The mobile carrier server 20 may receive the information about the maintenance of the corresponding radar terminal from the manufacturer server 10 and may manage the information.

In addition, the mobile carrier server 20 may refund the premium of a vehicle to which the radar terminal is installed to the insurance company server 30 according to a preset discount rate.

To this end, similarly with the manufacturer server 10, the mobile carrier server 20 may include a database for storing various kinds of information, a communication unit and a control unit.

The property insurance company obtains the franchise for the radar terminal through a contact with a mobile communication service provider and provides information about radar terminals and service of the mobile communication service provider to the user terminal 40.

Thus, a property insurance company server (hereinafter, referred to as an ‘insurance company server’) 30 may receive information about insurance subscription of a user vehicle and an order for purchasing a radar terminal from the user terminal 40 and transmit the information to the mobile carrier server 20. The insurance company server 30 may discount the premium of the user to as much as the refund from the mobile carrier server 20.

To this end, similarly with the manufacturer server 10, the insurance company server 30 may include a database for storing various kinds of information, a communication unit and a control unit.

The user terminal 40 accesses to the insurance company server 30 to receive information about the radar terminal and the premium discount and information about services provided from the mobile communication service provider from the insurance company server 30 when the vehicle insurance is subscribed, and offers a purchase of a radar terminal.

In addition, the user terminal 40 accesses to the mobile carrier server 20 to transmit information about an order for a radar terminal and settle the payment.

In addition, when the radar terminal is required to be maintained or repaired while being used, the user terminal 40 accesses to the manufacturer server 10 to request the maintenance and repair of the radar terminal.

The user terminal 40 may be a personal information terminal, such as a personal computer, a laptop computer, a smart phone, etc. capable of communicating with the manufacturer server 10, the mobile carrier server 20 and the insurance company server 30 through Internet or a mobile communication network.

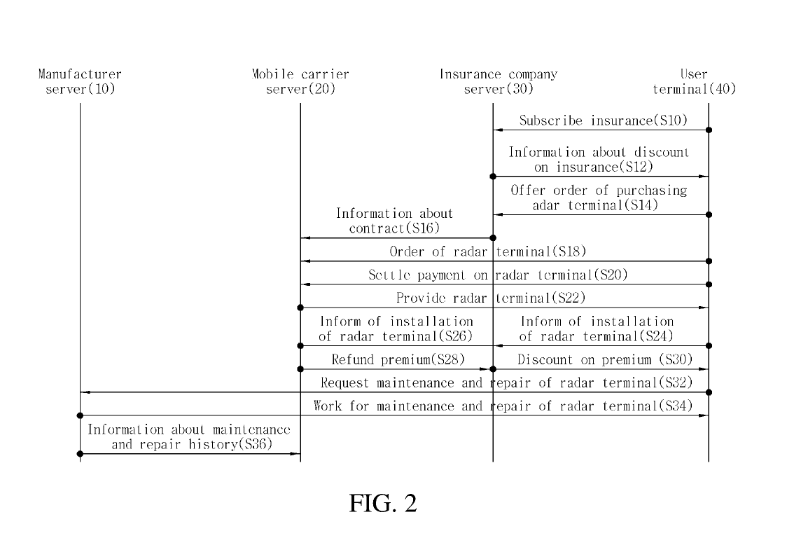

Next, a managing method of the system for managing a radar terminal according to the first embodiment of the disclosure will be described in detail with reference to FIG. 2.

FIG. 2 is a flowchart illustrating a managing method of the system for managing a radar terminal according to the first embodiment of the disclosure.

In step S10 of FIG. 2, the user terminal (40) accesses to the insurance company server 30 to subscribe insurance.

In step S12, the insurance server 300 introduces the radar terminal together with the insurance and provides information about discount on the premium when the radar terminal is installed. In addition, the insurance server 300 markets the concerned services of the mobile communication service provider to a user.

Thus, in step S14, the user decides whether the radar terminal is purchased based on the information about the discount on the insurance and offers the order of purchasing the radar terminal through the user terminal 40.

In step S16, the insurance company server 30 transmits the information about the purchase of the radar terminal requested through the user terminal 40 to the mobile carrier server 20.

In step S18, the user terminal 40 accesses to the mobile carrier server 20 to order the contracted radar terminal through the insurance company server 30 and fulfills the order through a new service contract with the mobile communication service provider.

Then, in step S20, the user terminal 40 settles the payment on the radar terminal in the state of accessing to the mobile carrier server 20.

In step S22, the mobile carrier server 20 receives the information about the order for the radar terminal ordered through the user terminal 40 and the insurance company server 30 and transmits the order information to the installation terminal previously contracted such that the radar terminal is provided to the user to be installed to a vehicle of the user.

In step S24, when the installation of the radar terminal is completed, the user terminal 40 informs the insurance company server 30 of the fact that the installation of the radar terminal is completed.

In this case, the insurance company server 30 informs the mobile carrier server 20 of the fact received from the user terminal 40 that the installation of the radar terminal is completed.

Thus, the mobile carrier server 20 refunds the premium corresponding to the discount rate, which is preset to the installation of the radar terminal, to the insurance company server 30.

In this case, the manufacturer server 40 may request the payment on the radar terminal installed to the vehicle of the user to the mobile carrier server 20 and the payment may be settled.

In step S30, the insurance company server 30 may discount the premium of the user and inform the user terminal 40 of the discount result. The user terminal 40 may pay the discounted premium or get a refund of the discounted premium.

Meanwhile, in step S32, when the radar terminal installed to a vehicle is out of order in use, the user terminal 40 may access to the manufacturer server 10 to request repair the radar terminal.

Then, in step S34, the manufacturer server 10 generates the maintenance and repair history after repairing the radar terminal and stores the maintenance and repair history in the data base to be managed.

In step S36, the manufacturer server 10 may provide the maintenance and repair history to the mobile carrier server 20.

As described above, the disclosure may induce the radar terminal to be popularized in conjunction with the manufacturer server, the mobile carrier server and the insurance company server through the insurance model of the radar terminal having the functions of alerting a collision and recording an accident, and may manage information about the contract of the order for the radar terminal, the trade in the radar terminal, and the maintenance and repair history of the radar terminal.

Thus, according to the disclosure, a new revenue model may be created without any burden of the premium reduction due to the reduction of the number of vehicles subscribed in insurance of a property insurance company and the premium discount supported by a mobile communication service provider. In addition, the new revenue model may allow the mobile communication service provider to obtain sales profit due to the increase of the number of subscribers. Further, the disclosure may enhance the brand value of a radar terminal manufacturer and may market the radar terminal through a mobile communication service provider and a property insurance company so that a stable market may be formed.

### Second Embodiment

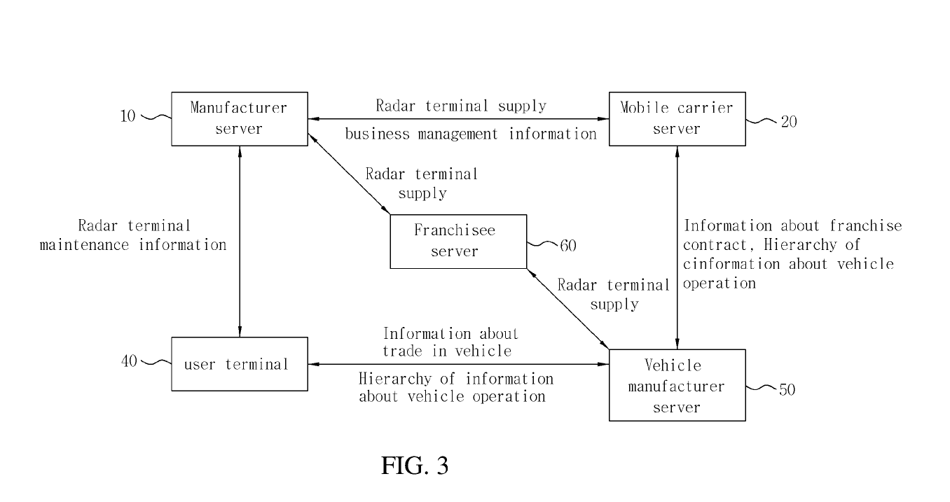

Next, a system for managing a radar terminal and a method thereof according to a second embodiment of the disclosure will be described in detail with reference to FIG. 3.

FIG. 3 is a block diagram illustrating a system for managing a radar terminal according to the second embodiment of the disclosure.

In the first embodiment, a manufacturer model, which induces the radar terminal to be installed in a before-market in which a vehicle is manufactured in conjunction with a vehicle manufacturer, will be described.

A system for managing a radar terminal according to the second embodiment may include a manufacturer server 10 for supplying a radar terminal having functions of altering a collision and recording an accident and storing information about manufacture of the radar terminal having the functions of alerting a collision and recording an accident, a mobile carrier server 20 for managing information about trade in the radar terminal, maintenance of the radar terminal, and business for the radar terminal in conjunction with the manufacturer server 10, and providing a program in conjunction of a radar terminal and hierarchy of information about a vehicle operation, a vehicle manufacturer server 50 for managing information about a vehicle on which the radar terminal is mounted, and a user terminal 40 for receiving information about the radar terminal from the vehicle manufacturer server 50 and transmitting information about an offer of an order when a new-vehicle purchasing contract is made.

In addition, the system for managing a radar terminal according to the second embodiment may further include a franchisee server 60 for receiving information about the offer of the purchase order from the vehicle manufacturer server 50 and transmitting information about the supply of the radar terminal to the vehicle manufacturer server 50 when an installation of the radar terminal is completed.

In the second embodiment, a vehicle manufacturer obtains the franchise for the radar terminal through a contact with a mobile communication service provider and provides information about the radar terminal and service provided by the mobile communication service provider to the user terminal 40.

A franchisee obtains right to supply the radar terminal through a contact with a manufacturer and supplies radar terminals to the vehicle manufacturer.

The mobile carrier server 20 may provide the program in conjunction of the radar terminal and the hierarchy of the information about the vehicle operation to the user terminal 40.

In this case, the program provided from the mobile carrier server 20 may include a navigation program or an application.

That is, according to the system for managing a radar terminal of the second embodiment of the disclosure, when a new-vehicle purchasing contract is made, the vehicle manufacturer server 50 provides information about a radar terminal to the user terminal 40 and a program such as a navigation application in conjunction with the radar terminal and hierarchy of information about a vehicle operation are provided from the mobile carrier server 20 to the user terminal 40.

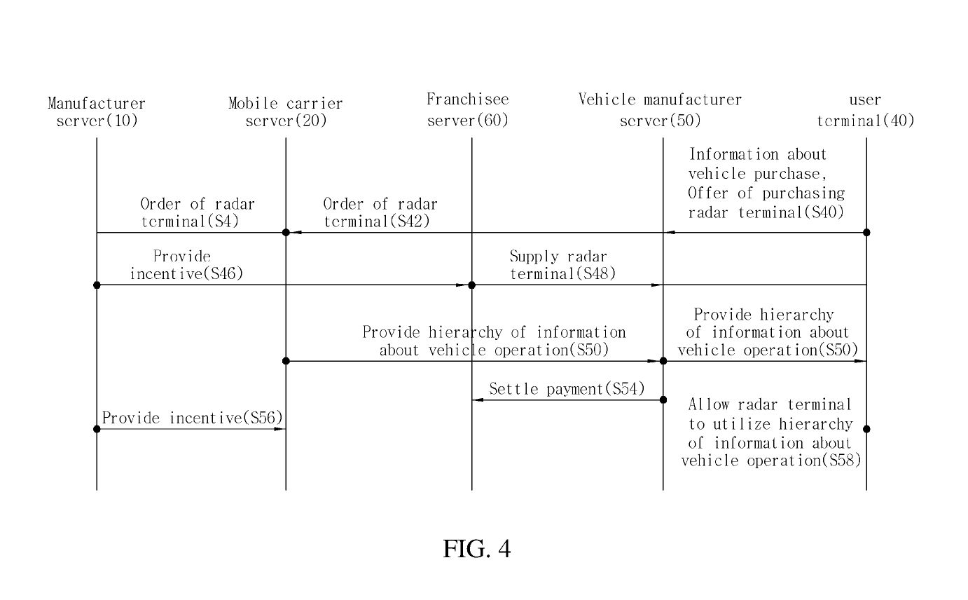

Next, a managing method of the system for managing a radar terminal according to the second embodiment of the disclosure will be described in detail with reference to FIG. 4.

FIG. 4 is a flowchart illustrating a managing method of the system for managing a radar terminal according to the second embodiment of the disclosure.

In S40 of FIG. 4, the user terminal 40 accesses to the vehicle manufacturer server 50 to receive information about a radar terminal together with information about a vehicle to be purchased from the vehicle manufacturer server 50 and transmits information about the offers of purchasing a vehicle and a radar terminal.

The vehicle manufacturer server 50 transmits information about an order for a radar terminal to the mobile carrier server 20 in step S42 and the mobile carrier server 20 transmits the information about the order for a radar terminal to the manufacturer server 10 in step S44.

In this case, the manufacturer supplies the radar terminal to the franchisee and the franchisee provides the radar terminal to the vehicle manufacturer.

In steps S46 and S48, the manufacturer server 10 generates information about the supply of the radar terminal and transmits the generated information to the vehicle manufacturer server 50 through the franchisee server 50.

Meanwhile, the mobile carrier server 20 may provide a program such as a navigation application in conjunction with the radar terminal and hierarchy of information about a vehicle operation to the user terminal 40 through the vehicle manufacturer server 50.

In step S54, the vehicle manufacturer server 50 accesses to the franchisee server 60 to settle the payment on the radar terminal installed to a vehicle, and the franchisee server 60 accesses to the manufacturer server 10 to settle the payment on the radar terminal.

Then, in step S56, the manufacturer server 10 may access to the mobile carrier server 20 to pay an incentive to the radar terminal sale to the mobile communication service provider.

Thus, the user terminal 40 may use the program in conjunction with the radar terminal and the hierarchy of information about a vehicle operation in step S58.

Meanwhile, as described in the first embodiment, when the radar terminal installed to a vehicle is out of order in use, the user terminal 40 may access to the manufacturer server 10 to request repair the radar terminal. Then, the manufacturer server 10 may generate the maintenance and repair history after repairing the radar terminal, store the maintenance and repair history in the data base to be managed, and provide the maintenance and repair history to the mobile carrier server 20.

As described above, according to the disclosure, when a new-vehicle purchasing contract is made, the information about a radar terminal may be provided from the vehicle manufacturer server to the user terminal 40, and a program such as a navigation application and hierarchy of information about a vehicle operation may be provided to the vehicle and the user terminal.

Thus, the disclosure may allow a vehicle manufacturer to create new revenue through brand marketing using vehicle accident reduction and preoccupancy of radar terminal installation market and increase the number of subscribers of a mobile communication service provider to increase the sales profit. In addition, according to the disclosure, a new revenue model may be created by providing a program in conjunction with the radar terminal and the hierarchy of information about a vehicle operation, the brand value of a manufacturer may be increased, and a stable market may be formed.

Although the invention made by the present inventor has been described in detail according to the embodiment, the disclosure is not limited to the embodiment and it is understood that various modifications may be made without departing from the essence of the disclosure.

### Industrial Applicability

The disclosure may be applicable to a technique concerning a system for managing a radar terminal and a method thereof which may induce the radar terminal to be popularized in conjunction with the manufacturer server, the mobile carrier server and the insurance company server through the insurance model of the radar terminal having the functions of alerting a collision and recording an accident, and may manage information about the contract of the order for the radar terminal, the trade in the radar terminal, and the maintenance and repair history of the radar terminal.

1. A system for managing a radar terminal, the system comprising:
a manufacturer server for storing information about manufacture of the radar terminal which provides a function of alerting a collision and recording an accident;
a mobile carrier server for managing information about trade in the radar terminal, maintenance of the radar terminal, and business for the radar terminal in conjunction with the manufacturer server;
an insurance company server for managing information about insurance of a vehicle on which the radar terminal is mounted; and
a user terminal for communicating with the mobile carrier server to transmit or receive information about an order and payment for the radar terminal, and trade in the radar terminal, and accessing to the manufacturer server to request maintenance and transmit or receive information about maintenance history,
wherein the insurance company server provides information about the radar terminal and discount on a premium to the user terminal.

2. A system for managing a radar terminal, the system comprising:
a manufacturer server for storing information about manufacture of a radar terminal which provides a function of alerting a collision and recording an accident;
a mobile carrier server for managing information about trade in the radar terminal, maintenance of the radar terminal, and business for the radar terminal in conjunction with the manufacturer server, and providing a program in conjunction of a radar terminal and hierarchy of information about a vehicle operation;
a vehicle manufacturer server for managing information about a vehicle on which the radar terminal is mounted;
a user terminal for receiving information about the radar terminal from the vehicle manufacturer server to offer a purchase order when a new-vehicle purchasing contract is made, and for accessing to the manufacturer server to request maintenance and transmit or receive information about maintenance history; and
a franchisee server for receiving information about the offer of the purchase order from the vehicle manufacturer server and transmitting information about the supply of the radar terminal to the vehicle manufacturer server when an installation of the radar terminal is completed.

3. The system of claim 1, wherein the mobile carrier server provides the program in conjunction of the radar terminal and the hierarchy of the information about the vehicle operation to the user terminal of a user using the radar terminal.

4. A method of managing a radar terminal, the method comprising:
(a) providing information about the radar terminal and discount of a premium from an insurance company server to a user terminal, wherein the radar terminal provides functions of alerting a collision and recording an accident;
(b) offering an order for the radar terminal to the insurance company server and accessing to a mobile carrier server to offer a service reservation by the user terminal;
(c) refunding a premium corresponding to a preset discount rate to the insurance company server by the mobile carrier server when installation of the radar terminal to a user vehicle is completed;
(d) providing information about the discounted premium from the insurance company server to the user terminal;
(i) generating information about supplying and maintenance history of the radar terminal to provide the generated information to the mobile carrier server by a manufacturer server; and
(j) managing the information about supplying and maintenance history of the radar terminal by the mobile carrier server.

5. A method of managing a radar terminal, the method comprising:
(e) providing information about a vehicle and a radar terminal from a vehicle manufacturer server to a user terminal, wherein the radar terminal provides functions of alerting a collision and recording an accident;
(f) offering an order for the radar terminal to the insurance company server by the user terminal;
(g) generating information about supplying of the radar terminal by the manufacturer server when the radar terminal is supplied based on the radar terminal offering and installed to a vehicle of a user;
(h) settling a payment on the radar terminal from the vehicle manufacturer server to a franchisee server and providing an incentive from the manufacturer server to a mobile carrier server;
(i) generating information about supplying and maintenance history of the radar terminal to provide the generated information to the mobile carrier server by the manufacturer server; and
(j) managing the information about supplying and maintenance history of the radar terminal by the mobile carrier server.

6. The method of claim 4, further comprising (k) providing a program in conjunction of the radar terminal and hierarchy of the information about a vehicle operation from the mobile carrier server to the user terminal.

7. The system of claim 2, wherein the mobile carrier server provides the program in conjunction of the radar terminal and the hierarchy of the information about the vehicle operation to the user terminal of a user using the radar terminal.

8. The method of claim 5, further comprising (k) providing a program in conjunction of the radar terminal and hierarchy of the information about a vehicle operation from the mobile carrier server to the user terminal.
